(19) United States
(12) Patent Application Publication
(10) Pub. No.: US 2014/0001330 A1
(43) Pub. Date: Jan. 2, 2014

(54) WALL HANGING LOCKING PIECE FOR LCD DEVICE, BACKPLANE, AND LCD DEVICE

(71) Applicant: Gang Yu, Shenzhen (CN)

(72) Inventor: Gang Yu, Shenzhen (CN)

(21) Appl. No.: 13/578,186

(22) PCT Filed: Jul. 9, 2012
(86) PCT No.: PCT/CN2012/078341

§ 371 Date: Aug. 9, 2012

(30) Foreign Application Priority Data
Jul. 2, 2012 (CN) 201210223865.5

(51) Int. Cl. F16M 13/02

(52) U.S. Cl. 248/231.91

(57) ABSTRACT

The locking piece is formed by machining a long plate-shaped piece, and includes a lug boss, and extension parts formed by bending two ends of the lug boss. The locking piece is fixed to the backplane of a liquid crystal display (LCD) device by the extension parts, and a top of the lug boss is configured with a locking hole used to lock the LCD device on the wall hanging. In the present disclosure, because the locking piece has a simple structure, relative to the bolts, the locking piece is only machined by simple sheet metal machining technology.

### TECHNICAL FIELD

The present disclosure relates to the field of liquid crystal displays (LCDs), and more particularly to a wall hanging locking piece for an LCD device, a backplane, and an LCD device.

### BACKGROUND

Because of the advantages of light weight, small thickness, liquid crystal display (LCD) devices have been favored by more and more consumers. Because of small thickness, in some decoration design, LCD devices are directly fixed to the wall surface without using tables for placing the LCD devices. Thus, the room space is greatly saved, and the wall hanging design for LCD devices is generated.

As shown in FIG. 1, to fix an LCD device to the wall surface, in the structure design of the LCD device, a backplane 100 of the LCD device is required to be riveted with bolts 200, the bolts 200 are configured with holes, the holes are internally configured with internal threads, and the LCD device is fixed to the wall surface by the matching of screws and the threads. Machined by milling, the bolts 200 have a high machining cost.

### SUMMARY

In view of the above-described problems, the aim of the present disclosure is to provide a low-cost wall hanging locking piece for a liquid crystal display (LCD) device, a backplane, and an LCD device.

The aim of the present disclosure is achieved by the following technical scheme.

A wall hanging locking piece for an LCD device comprises a lug boss, and extension parts formed by bending two ends of the lug boss. The locking piece is fixed to a backplane of the LCD device by the extension parts, and a top of the lug boss is configured with a locking hole used to lock the LCD device on the wall hanging.

In one example, the lug boss comprises two side walls and a top connecting the two side walls. At least one adding layer which is arranged in parallel with the top is arranged inside the lug boss and between the two side walls. The adding layer is also configured with a locking hole, and the locking hole of the adding layer and the locking hole of the top of the lug boss are coaxially arranged. The extension depth of the locking hole of the top is added by the adding layer and the locking hole of the adding layer, and thus multipoint support is formed; thus, more reliable locking support can be configured.

In one example, a gap is arranged between the adding layer and the top of the lug boss, and a gap is also arranged between the adding layers. The distance between the locking holes is added by the gap, and then the depth of the overall locking hole is added, thereby increasing the locking reliability.

In one example, one adding layer is arranged inside the lug boss. Two-point support is formed by one adding layer, the depth of the locking hole is added, and then reliable support is formed.

In one example, the adding layer is formed by stamping on one of the two side walls, and one end of the adding layer is connected with the side wall. One adding layer with simple structure is formed by directly stamping the side wall without additionally adding material nor adding a structure used for fixing the adding layer.

In one example, two adding layers which are arranged in parallel with the top are arranged inside the lug boss and between the two side walls. The two adding layers are formed by stamping on the two side walls, and the two adding layers are respectively connected with the two side walls. By using the two side walls, two adding layers can be formed, and multipoint support can be formed, thereby increasing the locking reliability.

In one example, the extension parts are configured with mounting holes, and the locking piece is arranged on the backplane of the LCD device through the mounting holes. The machining time of the backplane is affected by the process of riveting the bolts onto the backplane, and then the machining cost of the backplane is added. The locking piece can be arranged on the backplane by using screws through the mounting holes of the extension parts; thus, the technology of riveting the locking piece on the backplane can be reduced, and the machining efficiency of the backplane is increased.

In one example, the locking piece is formed by sheet metal machining technology. Sheet metal has the advantages of high machining efficiency, simple machining mode, and low cost.

A backplane comprises the locking piece mentioned above.

An LCD device comprises the backplane mentioned above.

In the present disclosure, because of being configured with a lug boss and extension parts formed by bending two ends of the lug boss, the locking piece has a simple structure. Such a structure can be formed by sheet metal machining technology with the advantages of high machining efficiency and simple process. The machine-formed lug boss can provide a structure used to lock the LCD device onto the wall hanging, and the extension parts can be directly fixed to the backplane of the LCD device. Particularly, for a plate-shaped piece, the plate-shaped piece can be machined by the sheet metal machining technology with high machining efficiency. Therefore, relative to the bolts, the locking piece is only machined by the simple sheet metal machining technology with the advantages of high machining speed, high efficiency and low material consumption without using the machining modes of high cost such as milling, etc. Thus, the machining cost and material cost of the mode are lower than those of the mode of using bolts.

### BRIEF DESCRIPTION OF FIGURES

FIG. 1 is a simplified structure diagram of a typical locking piece for an LCD device fixed to a backplane;

FIG. 2 is a simplified structure diagram of a locking piece of an example of the present disclosure; and

FIG. 3 is another simplified structure diagram of a locking piece of an example of the present disclosure.

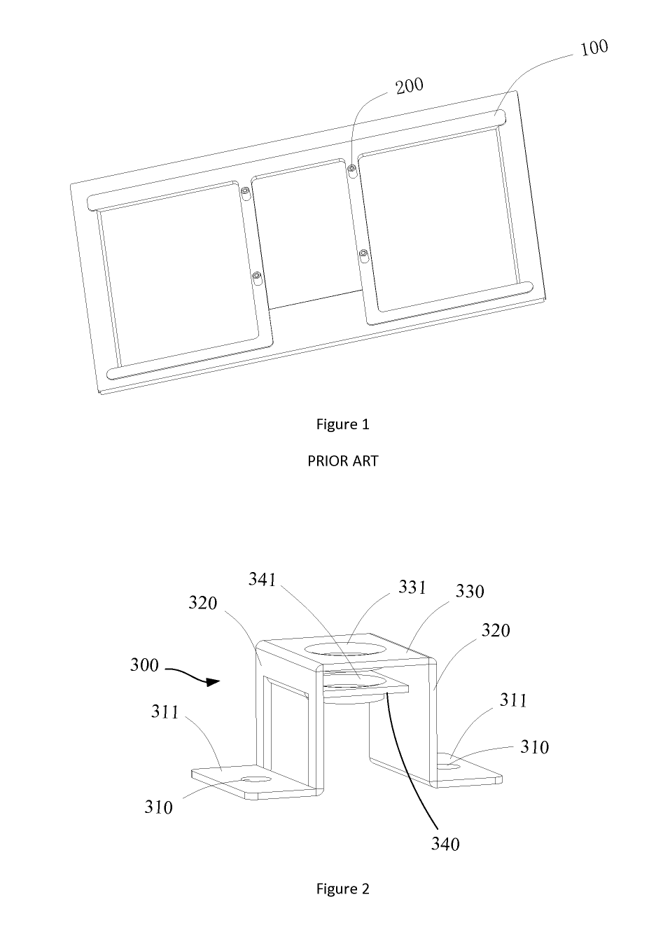

Legends: 100. backplane; 200. bolt; 310. mounting hole; 311. extension part; 320. side wall; 330. top; 331. locking hole; 340. adding layer; 341. locking hole.

### DETAILED DESCRIPTION

The present disclosure will be further described in accordance with the Figures and exemplary examples.

FIG. 2 shows a specific example of a wall hanging locking piece for a liquid crystal display (LCD) device of the present disclosure. The locking piece is formed by sheet metal machining, and comprises a lug boss formed by sheet metal machining, and extension parts 311 formed on two ends of the lug boss after forming the lug boss. The locking piece is fixed to a backplane of the LCD device by the extension parts 311, and a top of the lug boss is configured with a locking hole 331 used to lock the LCD device on the wall hanging. The lug boss comprises two side walls 320 and a top 330 connecting the two side walls. The lug boss plays the role of providing a structure which is extended outside a back cover of the LCD device from the backplane and fixes the LCD device to the wall hanging. Because the backplane of the LCD device is of a metal structure in general, the strength of the backplane is higher than that of the back cover of the LCD device; thus, the locking piece is required to be fixed to the backplane.

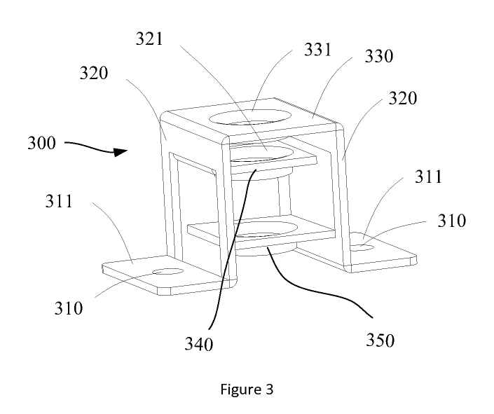

One adding layer 340 which is arranged in parallel with the top 330 is arranged inside the lug boss and between the two side walls 320. The adding layer 340 is also configured with a locking hole 341, and the locking hole 341 of the adding layer 340 and the locking hole 331 of the top 330 of the lug boss are coaxially arranged. Thus, the locking hole 341 of the adding layer 340 corresponds to extending the depth of the locking hole 331 of the top 330 of the lug boss, and also corresponds to providing two-point support, thereby increasing the locking support reliability of the locking piece. In the example, the adding layer 340 is formed by stamping on one side wall 320 of the lug boss, and one end of the formed side wall 320 is still connected to the side wall. Thus, no extra material is required to be added, and the fixed structure for the adding layer 340 is not required to be additionally added. Optionally, the side wall 320 of the other side can further be stamped with one adding layer. As shown in FIG. 3, another adding layer 350 is formed by stamping the other side wall 320, thereby forming two adding layers. Thus, the depth of the overall locking hole is added, and the reliability of locking the locking piece on a wall hanging is increased. However, to ensure the overall strength of the locking piece, only one adding layer 340 is arranged in the example. Optionally, the adding layer can also be formed by additionally arranging and filling a sheet metal component inside the lug boss to form a multilayer adding layer. Thus, the depth of the locking hole can be added, and the structural rigidity of the locking piece cannot be reduced. However, the machining mode is complicated.

The locking hole of the top of the lug boss is internally configured with internal threads, and the locking piece is directly locked onto the wall hanging by screws. For the adding layer formed by thread rolling, all the internal threads of the locking holes of the adding layers can be directly formed by one-time thread rolling. Thus, the overall depth of the internal threads is added, and then the locking reliability of the locking piece is increased.

The extension parts 311 of the locking piece are configured with mounting holes 310, and the locking piece is fixed to the backplane of the LCD device through the mounting holes 310. Thus, the technology of riveting the locking piece on the backplane is reduced, and the machining efficiency of the backplane is increased.

The present disclosure is described in detail in accordance with the above contents with the specific exemplary examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A wall hanging locking piece for a liquid crystal display (LCD) device, comprising:
a lug boss; and
extension parts formed by bending two ends of the lug boss;
wherein the wall hanging locking piece is fixed to a backplane of the LCD device by the extension parts, and a locking hole is arranged on a top of the lug boss and used to lock the LCD device on a wall hanging.

2. The wall hanging locking piece for an LCD device of claim 1, wherein the lug boss comprises two side walls and a top connecting the two side walls; at least one adding layer which is arranged in parallel with the top is arranged inside the lug boss and between the two side walls; the adding layer comprises a locking hole, and the locking hole of the adding layer and the locking hole of the top of the lug boss are coaxially arranged.

3. The wall hanging locking piece for an LCD device of claim 2, wherein a gap is arranged between the adding layer and the top of the lug boss, and a gap is also arranged between the adding layers.

4. The wall hanging locking piece for an LCD device of claim 2, wherein one adding layer is arranged inside the lug boss.

5. The wall hanging locking piece for an LCD device of claim 4, wherein the adding layer is formed by stamping on one of the two side walls, and one end of the adding layer is connected with the side wall.

6. The wall hanging locking piece for an LCD device of claim 2, wherein two adding layers which are arranged in parallel with the top are arranged inside the lug boss and between the two side walls; the two adding layers are formed by stamping on the two side walls, and the two adding layers are respectively connected with the two side walls.

7. The wall hanging locking piece for an LCD device of claim 1, wherein the extension parts comprise mounting holes, and the locking piece is arranged on the backplane of the LCD device through the mounting holes.

8. The wall hanging locking piece for an LCD device of claim 1, wherein the locking piece is formed by sheet metal machining technology.

9. A backplane, comprising:
a wall hanging locking piece for an liquid crystal display (LCD) device, and the wall hanging locking piece is arranged on the backplane;
wherein the wall hanging locking piece comprises a lug boss and extension parts formed by bending two ends of the lug boss; wherein the wall hanging locking piece is fixed to the backplane of the LCD device by the extension parts, and a locking hole is arranged on a top of the lug boss and used to lock the LCD device on a wall hanging.

10. A liquid crystal display (LCD) device, comprising:
a backplane; and
a wall hanging locking piece for the LCD device, and the wall hanging locking piece is arranged on the backplane;
wherein the wall hanging locking piece comprises a lug boss and extension parts formed by bending two ends of the lug boss; wherein the wall hanging locking piece is fixed to the backplane of the LCD device by the extension parts, and a locking hole is arranged on a top of the lug boss and used to lock the LCD device on a wall hanging.

11. The LCD device of claim 10, wherein the lug boss comprises two side walls and a top connecting the two side walls; at least one adding layer which is arranged in parallel with the top is arranged inside the lug boss and between the two side walls; the adding layer comprises a locking hole, and the locking hole of the adding layer and the locking hole of the top of the lug boss are coaxially arranged.

12. The LCD device of claim 11, wherein a gap is arranged between the adding layer and the top of the lug boss, and a gap is also arranged between the adding layers.

13. The LCD device of claim 11, wherein one adding layer is arranged inside the lug boss.

14. The LCD device of claim 13, wherein the adding layer is formed by stamping on one of the two side walls, and one end of the adding layer is connected with the side wall.

15. The LCD device of claim 11, wherein two adding layers which are arranged in parallel with the top are arranged inside the lug boss and between the two side walls; the two adding layers are formed by stamping on the two side walls, and the two adding layers are respectively connected with the two side walls.

16. The LCD device of claim 10, wherein the extension parts comprise mounting holes, and the locking piece is arranged on the backplane of the LCD device through the mounting holes.

17. The LCD device of claim 10, wherein the locking piece is formed by sheet metal machining technology.
